(19) United States
(12) Patent Application Publication
(10) Pub. No.: US 2012/0094721 A1
(43) Pub. Date: Apr. 19, 2012

(54) METHOD AND APPARATUS FOR SHARING OF DATA BY DYNAMIC GROUPS

(75) Inventors: Hans Peter Brondmo, San Francisco, CA (US); Setha Margaret Olson, Lincoln, MA (US); Myles Thomas Wang, San Francisco, CA (US); Jeffrey Lapierre, Santa Cruz, CA (US)

(73) Assignee: Nokia Corporation, Espoo (FI)

(21) Appl. No.: 13/233,793

(22) Filed: Sep. 15, 2011

Related U.S. Application Data
(60) Provisional application No. 61/383,073, filed on Sep. 15, 2010.

(51) Int. Cl. G06F 15/16; H04W 88/02

(52) U.S. Cl. 455/566; 709/204

(57) ABSTRACT

Techniques for sharing of data by dynamic groups include determining a first digital data set to be shared by devices of members of a first group. One or more entities are determined who are currently members of the first group. At least in part, actions are caused, which result in a change in members of the first group based on input from any of the members of the first group. In some embodiments, techniques include determining a different second digital data set to be shared by devices of members of a second group.

### RELATED APPLICATIONS

This application claims the benefit of the earlier filing date under 35 U.S.C. §119(e) of U.S. Provisional Application Ser. No. 61/383,073 filed Sep. 15, 2010, entitled “Method and Apparatus for Sharing of Data by Dynamic Groups,” the entirety of which is incorporated herein by reference.

### BACKGROUND

Service providers and device manufacturers (e.g., wireless, cellular, etc.) are continually challenged to deliver value and convenience to consumers by, for example, providing compelling network services. In many popular network services, digital data is shared. In one group of data sharing services, data is communicated from one user of a network to user-selected recipients. For example using electronic mail (email), short message service (SMS) messages, instant messaging (IM) messages, a user sends digital data to one or more parties known to the user. While the user expects the data is relevant to the recipients, the user may be unaware of others for whom the data is relevant. In a second group of services, recipients volunteer for receiving data from a user. However, in this second group of services, data is shared among members of a large, relatively fixed group regardless of relevance of the data to one or more members. For example, comments and other digital objects posted to a social network page of a user are shared among persons accepted as friends of the user, no matter the relevance of the post. Similarly a TWITTER message is sent to self-selected followers of a user regardless of the relevance of the message to one or more followers. Because others volunteer to join these groups, the membership in services of the second group can become large and involve a wide range of interests. For example, social network groups can include many hundreds of members. Some TWITTER groups include thousands and even hundreds of thousands followers. Thus, only the most general posts are appropriate for sharing.

### SOME EXAMPLE EMBODIMENTS

Therefore, there is a need for an approach for sharing of data by dynamic groups based on relevance of data to be shared, that does not suffer one or more of the disadvantages of prior art approaches.

According to one embodiment, a method comprises determining a first digital data set to be shared by devices of members of a first group. The method also comprises determining one or more entities who are currently members of the first group. The method further comprises causing, at least in part, actions that result in a change in members of the first group based on input from any of the members of the first group.

According to another embodiment, an apparatus comprises at least one processor, and at least one memory including computer program code, the at least one memory and the computer program code configured to, with the at least one processor, cause, at least in part, the apparatus to determine a first digital data set to be shared by devices of members of a first group. The apparatus is also caused to determine one or more entities who are currently members of the first group. The apparatus is further caused to cause, at least in part, actions that result in a change in members of the first group based on input from any of the members of the first group.

According to another embodiment, a computer-readable storage medium carries one or more sequences of one or more instructions which, when executed by one or more processors, cause, at least in part, an apparatus to determine a first digital data set to be shared by devices of members of a first group. The apparatus is also caused to determine one or more entities who are currently members of the first group. The apparatus is further caused to cause, at least in part, actions that result in a change in members of the first group based on input from any of the members of the first group.

According to another embodiment, an apparatus comprises means for determining a first digital data set to be shared by devices of members of a first group. The apparatus also comprises means for determining one or more entities who are currently members of the first group. The apparatus further comprises means for causing, at least in part, actions that result in a change in members of the first group based on input from any of the members of the first group.

According to another embodiment, a method comprises facilitating access to at least one interface configured to indicate a first digital data set to be shared by devices of members of a first group. The interface is also configured to indicate one or more entities who are currently members of the first group. The interface is yet further configured to accept, from a member of the first group, input that indicates a change to members of the first group.

According to another embodiment, a method comprises facilitating access to at least one interface configured to allow access to at least one service, the at least one service configured to perform at least the steps of one of the above methods.

According to another embodiments, a computer program product includes one or more sequences of one or more instructions which, when executed by one or more processors, cause an apparatus to at least perform the steps of one of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of sharing of data by dynamic groups, according to one embodiment;

FIG. 2A is a diagram of the components of a data structure for a group wall that associates a digital data set with a dynamic group, according to one embodiment;

FIG. 2B is a diagram of the components of a message for an application programming interface on a server that provides sharing of data by dynamic groups, according to one embodiment;

FIG. 3 is a flowchart of a client process on user equipment for sharing of data by dynamic groups, according to one embodiment;

FIGS. 4A-4C are diagrams of user interfaces utilized in the processes of FIG. 3, according to various embodiments;

FIG. 5 is a flowchart of a server process for sharing of data by dynamic groups, according to one embodiment;

FIG. 6 is a flowchart of an agent process on a network service for sharing of data by dynamic groups, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program are disclosed for sharing of data by dynamic groups. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term digital data refers to any data that can be represented in machine-readable form, including data that can be used to present content for observation by a human, such as text, audio, music, images, videos, thumbnail representations of larger images, games, graphs, tables, maps, diagrams, documents, or spreadsheets, among others. A digital data item is a portion of digital data such as a single image, audio snippet or video clip that is presented as a whole and not sub-divided. A digital data set is a collection of one or more digital data items.

With respect to sharing digital data, as used herein, a group is a collection of one or more members. As used herein, a group wall is a digital data set that is to be shared by devices of all members of a particular group of entities. Each group member entity is a person or organization that operates at least one device connected to a communications network. The group wall can be viewed in whole or in part by any entity who is member of the particular group.

As used herein, a dynamic group is a group for which a change in members is based on input from any of the members of the group.

According to various embodiments, one or more group walls are established for corresponding dynamic groups. Thus the members of a dynamic group for a group wall can add or remove members based of any member's subjective response to the set of digital items being shared. Unlike email, the provider of the digital items need not know all the entities who will find the digital items of interest—the initial members can each add one or more other members, who, in turn, can add or remove other members. Unlike social networks or TWITTER, a different group is defined for each set of digital items to be shared. As the set of digital items evolves into more specific matters, one or more members not related to the specific matters can be removed. For convenience hereinafter, the term group wall refers to a group wall for a dynamic group, unless otherwise clear from the context. Although a single member generally creates the group wall, each member of the dynamic group has equal authority to add or remove members, post digital data items, or close the group wall.

As used herein, the term context refers to data that indicates the state of a device or the inferred state of a user of the device, or both. The states indicated by the context include time, recent applications running on the device, recent World Wide Web pages presented on the device, keywords in current communications (such as emails, SMS messages, IM messages), current and recent locations of the device (e.g., from a global positioning system, GPS, or cell tower identifier), movement, activity (e.g., eating at a restaurant, drinking at a bar, watching a movie at a cinema, watching a video at home or at a friend's house, exercising at a gymnasium, travelling on a business trip, travelling on vacation, etc.), emotional state (e.g., happy, busy, calm, rushed, etc.), interests (e.g., music type, sport played, sports watched), contacts, or contact groupings (e.g., family, friends, colleagues, etc.), among others, or some combination.

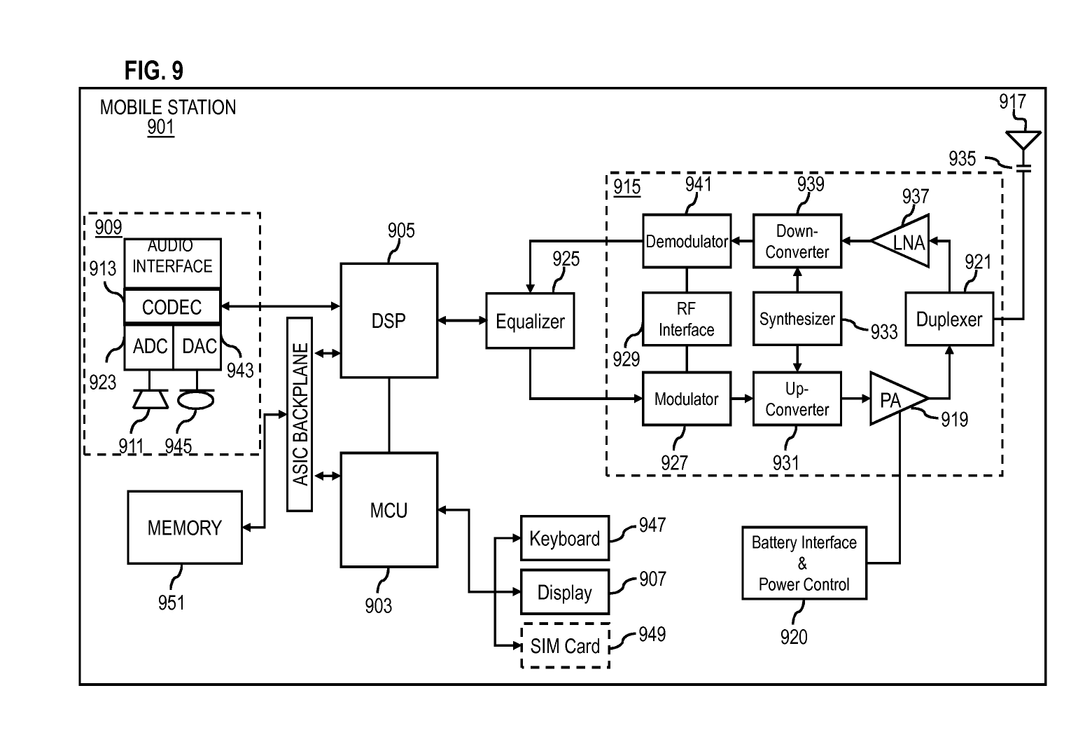

Although various embodiments are described with respect to sharing digital data on user mobile terminals, as shown in FIG. 9, among dynamic group members who are persons, it is contemplated that the approach described herein may be used with other devices connected to a communication network, such as desktop and laptop computers, operated by entities that represent individual persons or organizations of several persons.

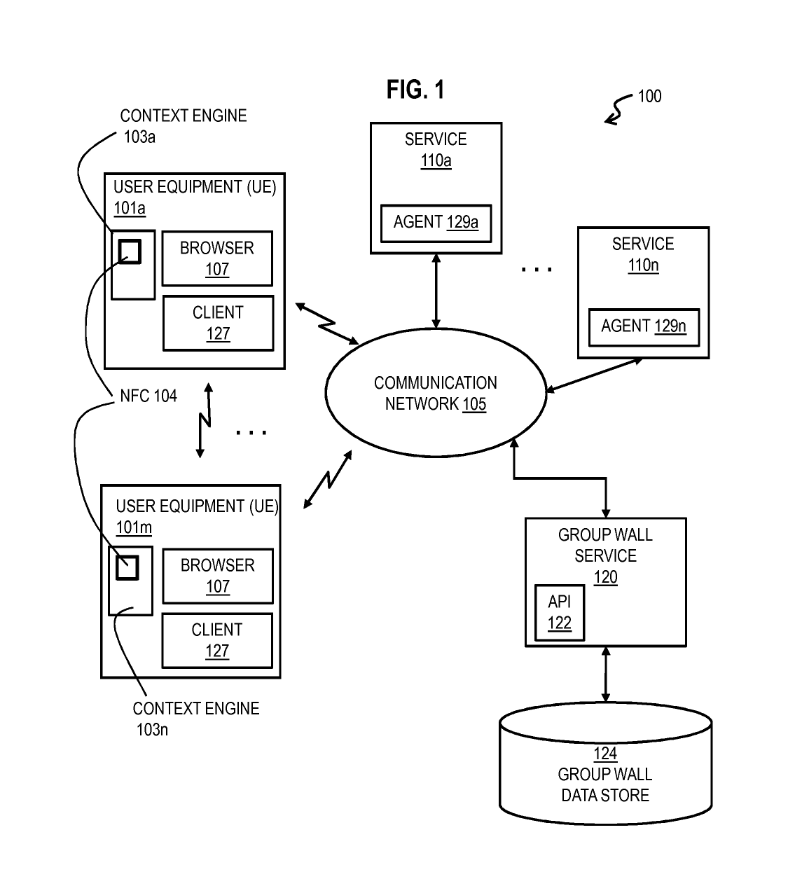

FIG. 1 is a diagram of a system 100 capable of sharing of data by dynamic groups, according to one embodiment. As shown in FIG. 1, the system 100 comprises user equipment (UE) 101a through 101m (collectively called UE 101 hereinafter) having connectivity to one or more network services 110a through 110n (collectively called network services 110, hereinafter) via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

When a first user of UE 101 (e.g., user of UE 101a) generates or obtains a digital data item locally on the UE 101 or remotely through one of the network services 110, the user may determine that the digital data item should be shared with one or more other users of UE 101 (e.g., user of UE 101m) who would find the subject matter of the data item of some interest or relevance. If the first user pastes the digital data item into an email or IM or SMS message, the first user can send the digital data item to a few or few dozen contacts. However, others who be interested, or their contact information, are unknown. One of the original recipients could forward the message to others known by the original recipient, but input from the entity receiving the forwarded message is not automatically shared with the original recipients and first user, or not easily shared with others to whom other recipients have forwarded the message. If, alternatively, the original user posts the data item to a social network page, or includes it in a TWITTER message, then hundreds or thousands of persons not interested in the item, or with whom the original user does not want to share the item, also receive the item.

To address this problem, the system 100 of FIG. 1 introduces the capability to share a digital data set with a dynamic group. The digital data items of a digital data set are posted to a group wall at a group wall service 120 and one or more other users are added as members to the group. The group wall service 120 notifies the other members of the group wall's existence and allows them to see the posted data items and otherwise operate on the group wall, e.g. to modify the group wall. Those other members may post comments or other digital data items to the group wall and add or remove members from the group. In this way, the group membership evolves to include those entities for whom the postings are relevant, as determined by the combined membership.

The group wall service 120 includes a group wall data store 124 that stores the digital data set in association with the group membership information. An API 122 allows other network services 110 to access the functionality of the group wall service 120, e.g., to incorporate into one or more World Wide Web pages or other applications provided by the other network services 110. The group wall service 120 acts indirectly with one or more UE 101 through a group wall agent process 129a through 129n (collectively called group wall agents 129 hereinafter) on corresponding network services 110 through 110n. For example, the network service 110 interacts directly with UE 101 through a World Wide Web browser 107 that presents pages provided and controlled by the network services 110 based on data exchanged with the group wall service 120 through agent 129 and API 122. In some embodiments, the group wall service 120 also acts directly with one or more UE 101, e.g., through a client process 127 that accesses the API 122 or through a World Wide Web browser 107 that presents pages provided and controlled by the group wall service 120.

The UE 101a through 101m also include corresponding context engines 103a through 103m respectively, collectively referenced hereinafter as context engines 103. The context engines 103 determine the state of each UE 101 or user thereof, or some combination, depending on the sophistication of the sensors and algorithms on each UE 101. Even simple UE 101 include context engines 103 that determine the equipment identifier for the UE 101, the current time, and an identifier of a network access node into communication network 105 with which the UE 101 directly communicates. In the illustrated embodiment, at least some context engines 103 include a near field communications (NFC) module 104 that detects other UE 101 within direct communication range. In some circumstances, at least, a UE 101a sends messages directly to such nearby UE 101m rather than indirectly through the network 105.

By way of example, the UE 101, network services 110 and group wall service 120 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Processes executing on various devices, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most devices (called nodes) connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages. As depicted in FIG. 1, the UEs 101a-101m include browsers 107.

Although processes and data structures are depicted in FIG. 1 as integral blocks in a particular arrangement for purposes of illustration, it is contemplated that the functions of these components, or portions thereof, may be combined in one or more components or performed by other components of equivalent functionality on the same or different or different number of devices connected to communication network 105.

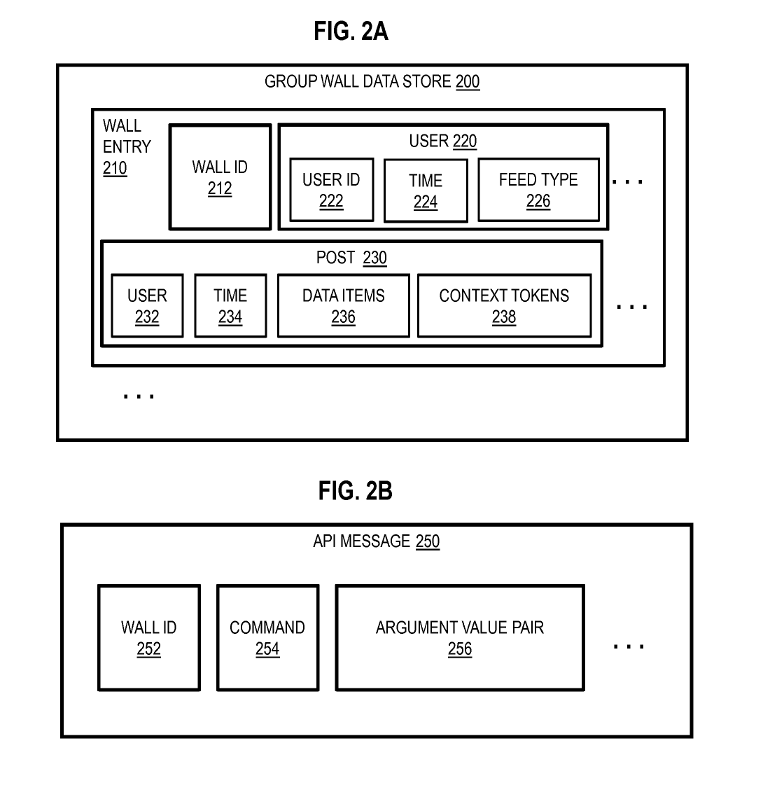

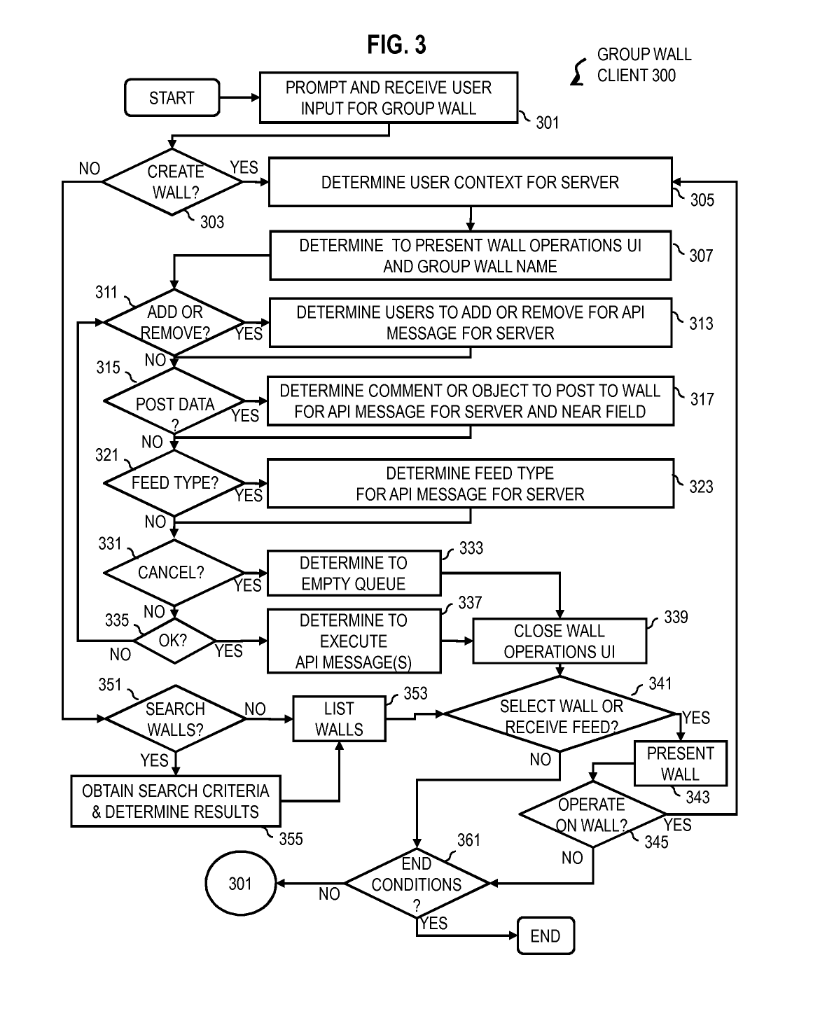

FIG. 2A is a diagram of the components of a data structure 200 for a group wall that associates a digital data set with a dynamic group, according to one embodiment. The data structure 200 is a particular embodiment of group wall data store 124 depicted in FIG. 1. Although data structures and messages and fields are depicted in FIG. 2A and FIG. 2B as integral blocks in a particular order on a single device for purposes of illustration, in other embodiments the data structures or messages or fields or portions thereof may be arranged in a different order in one or more messages or portions of memory or in one or more databases on one or more nodes connected to communications network 105, or one or more fields or portions thereof are omitted, or additional fields are added, of the message or data structure is changed in some combination of ways.

The group wall data structure 200 includes a wall entry field 210 for every group wall, with an ellipsis indicating the wall entry field 210 for other group walls. Thus data store 200 provides for determining a first digital data set to be shared by all members of a first group; but also provides for determining a different second digital data set to be shared by devices of all members of a second group. An advantage of collecting wall entry fields for multiple different group walls is that a search of multiple walls can be more easily accomplished with consumption of bandwidth on the network 105. The multiple wall entry fields 210 in data store 200 is an example means to achieve this advantage.

Each group wall entry field 210 includes a wall identifier (ID) field 212, one or more user fields 220 with an ellipsis indicating other user fields 220, and one or more post fields 230 with an ellipsis indicating other post fields 230. The collection of post fields 230 for a single wall entry record 210 constitutes a digital data set that is shared by all members of the group.

The wall ID field 212 holds data that indicates a unique identifier for the wall among all the group wall entry fields 210 in the data structure 200. For example, in some embodiments, the wall ID field includes a sequence number that uniquely identifies the wall. In some embodiments, the wall ID field 212 includes a name provided for the group wall based on input from a user who created the wall, such as a subject name specifically given, or key words associated with a data object or comments included in a first post to the wall, or some combination. In some embodiments the wall ID is based, at least in part, on the context of the UE 101 or user of UE 101 that created the wall. For example, if Alice created the group wall with a post about skiing, the wall name “Alice skiing” is included as a name for the wall in the wall ID field 212. An advantage of a sequence number is compact representation of unique values, and a wall ID that contains such a sequence number is an example means to achieve this advantage. An advantage of a user-supplied or inferred name is to avoid confusion of users by providing natural names that a user can more easily distinguish than two sequence numbers. Including a group wall name in the wall ID field 212 is an example means to achieve this advantage.

The user field 220 holds data that indicates an entity who is a member of the group which will share data on the group wall. In the illustrated embodiment, the user field 220 includes a user identifier (ID) field 222, a time field 224 and a feed type field 226.

The user ID field 222 holds data that uniquely indicates the entity who is a member, such as an email address or a cellular telephone number. In some embodiments, the user ID field 222 includes data that indicates a user name, such as family name and given name of a person or a corporate name of an organization. A unique user ID field offers the advantage of avoiding ambiguity about which users are which members of a group wall, and the user ID field is an example means for achieving this advantage. A user name offers the advantage of allowing a user to easily determine who is meant by a user ID so that decisions about whom to include and exclude can be input more accurately. Including the user name is an example means to achieve the advantage of greater accuracy in determining group membership.

The time field 224 holds data that indicates the time that the user was added to the group. Such a time is useful in order to determine how many past posts to the group wall should be sent for presentation at the UE 101 operated by the user identified in field 222. By avoiding obsolete or previously send posts, processing time on the hosts of service 120 and on UE 101 and bandwidth on network 105 are conserved. Including the time field 224 is an example means to achieve this advantage of lower processing and bandwidth consumption. In some embodiments, the time field 224 includes data that indicates a time when the user is removed from the group. Before being removed, the removal time for a user is omitted or filled with a null value. An advantage of including a removal time rather than deleting the user field 220 for the removed member is to allow for logic about inhibiting the adding of a member previously removed. A time of removal portion of the time field 224 is an example means to achieve this advantage.

The feed type field holds data that indicates how the user is to be notified of activity on the group wall. Activity includes any digital objects or comments posted to the group wall and the addition or removal of any members of the group. For example, data indicating simple notification results in a SMS message being sent to the member identified in field 222 when activity occurs on the group wall. The message includes a link to a webpage that displays the posts to the group wall. Data indicating a wall feed indicates all activity for the current group wall causes the wall to be presented on the UE 101 of the non-removed member indicated in field 222, e.g., by including the digital data set in a web page and opening a browser window on the UE 101 of the member. Data indicating an aggregate feed indicates that all activity on every wall for which the user identified in field 222 is a non-removed member is to be presented on the UE 101 of that member. For example, a user-specific web page is generated and all posts to all groups of which that user is a current member are complied on that webpage. When any material is added to that webpage, the browser window on the UE 101 of the member is opened, if not already opened, to present that web page of aggregated digital data items from multiple group walls. The feed type field is an example means of achieving the advantage of conserving network bandwidth and processing power on the UE 101 and host of the service 120 by only sending the data desired by the user.

In the illustrated embodiment, the post field 230 includes a user identifier (ID) field 232, a time field 234, a data items field 236 and a context tokens field 238.

The user field 232 holds data that indicates the member of the group who posted the next one or more digital data items to the group wall. The time field 234 holds data that indicates the time that the digital data items were posted. The data items field 236 indicates the one or more digital data items, such as the text of a comment, the universal resource identifier (URI) of a file holding the digital data item, such as an audio file or video file, a thumbnail of a data object stored in the file, or the digital item in its entirety. Any item to be shared is included in the data items field, including text generated by the group wall server that indicts when a member is added or removed from the group.

The context tokens field 238 holds data that indicates the context of the UE 101 or inferred context of the user of the UE 101 from which the posted digital data items were received. For example, the context tokens indicate the time and place of the UE 101 when the post was made and any inferred state of the user. Any method known in the art for expressing context may be used as the context tokens in field 238. The context tokens field 238 is an example means for achieving the advantage of providing the capability to search one or more group walls for posts that are related to a certain context, e.g., dining at a restaurant or Saturday evening clubs.

FIG. 2B is a diagram of the components of a message 250 for an application programming interface (API) 122 on a service 120 that provides sharing of data by dynamic groups, according to one embodiment. The message 250 is sent by client 127 or agent 129 to the API 122 of the group wall service 120. The message 250 includes a wall ID field 252, a command field 254 and one or more argument name and value pair fields 256. The use of an API is an example means to achieve the advantage of providing the functionality of the group wall service 120 to any network service 110, as well as the client 127. In some embodiments, the client 127 and network services 110 take control of user interfaces and just use the API to get and put data into the group wall data store 124. In some embodiments, one or more user interfaces are also provided by the group wall service 120 and are available through the API 122. An advantage of a user interface available through the service 120 is to reduce the time and expense of developing novel user interfaces on each client 127 or agent 129.

The wall ID field 252 holds data that indicates which group wall is to be operated on. The command field 254 holds data that indicates which API command is being executed. Each argument name and value pair field 256 holds data that indicates the values involved in executing the command.

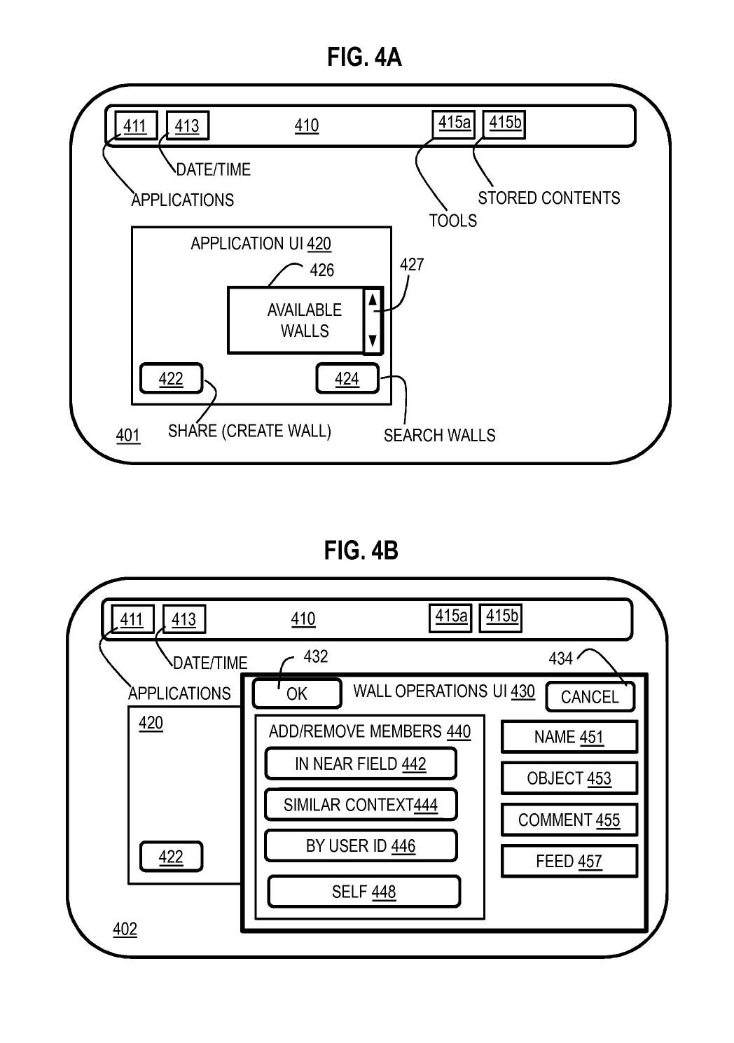

For example, in an illustrated embodiment the API accepts commands for wall modification operations CREATE, ADD, REMOVE, POST, COMMENT, FEED, and wall retrieval operations such as VIEW and SEARCH, as described in more detail below with reference to FIG. 3. In some embodiments, a MODIFY API command is included to request an interface to prompt the user for one or more of the above commands. In some embodiments all interfaces are controlled by the client 127 or agent 129; and a MODIFY API command is omitted.

The CREATE command is used to create a new group wall; and the API message 250 includes CREATE in field 254 and has an argument name value pair field 256 indicating the user who sends the command. In some embodiments, the API message has one or more argument name value pair fields 256 for context of the device sending the command and a field 256 for a user-supplied name for the group wall, if any. The CREATE command is an example means to achieve the advantage of signaling the start of a new group wall.

The ADD command is used to add members to the group; and the message 250 includes the wall ID in field 252, ADD in field 254 and an argument name value pair field 256 for each user, e.g., “USER ID=userid@emailservice.com” in field 256 as well as a field 256 for the sending user. Similarly, the REMOVE command is used to remove members from the group; and message 250 includes REMOVE in field 254 and an argument name value pair field 256 for each member to be removed, e.g., “USER ID=userid@emailservice.com” as well as a field for the sending user. The ADD and REMOVE commands are example means to achieve the advantage of dynamically changing the membership of the group.

The POST command indicates one or more digital data items to include in the digital data set; and message 250 includes the wall ID in field 252, POST in field 254 and an argument name value pair field 256 for the posting user and another field 256 for each digital data item being posted, e.g., “audio=URI of audio file” in one field 256 and “map=URI of map object” in another field 256. The COMMENT command indicates one or more comments to associate with a posted digital data item. The API message 250 includes COMMENT in field 254 and an argument name value pair field 256 for the commenting user and another field 256 to indicate the posted item and another argument name value pair field 256 to indicate the comment, e.g., “audio=URI of audio file” in one field 256 and “text=I love this song” in another field 256.

The FEED command indicates how a member is to be notified of activity in a group wall. The API message 250 includes FEED in field 254 and one argument name value pair field 256 to indicate the sending user and another field 256 to indicate the type of notification, e.g., “email,” or “SMS,” or “wall feed.” or “aggregate feed.”

The VIEW command indicates group wall to view. The API message 250 includes the wall ID in field 252, VIEW in field 254 and an argument name value pair field 256 for the requesting user.

The SEARCH command indicates search criteria for digital data items posted to any group wall for which the requesting user is a member. The SEARCH API message 250 includes a wall ID in field 252 only if the search is confined to a single wall (otherwise a null value is there), SEARCH in field 254, and an argument name value pair field 256 for the requesting user and another field 256 for each search criterion, e.g., “keyword=fish” and “context=current location” and “context=lunch” to find group walls that have posts related to fish for lunch at a nearby location.

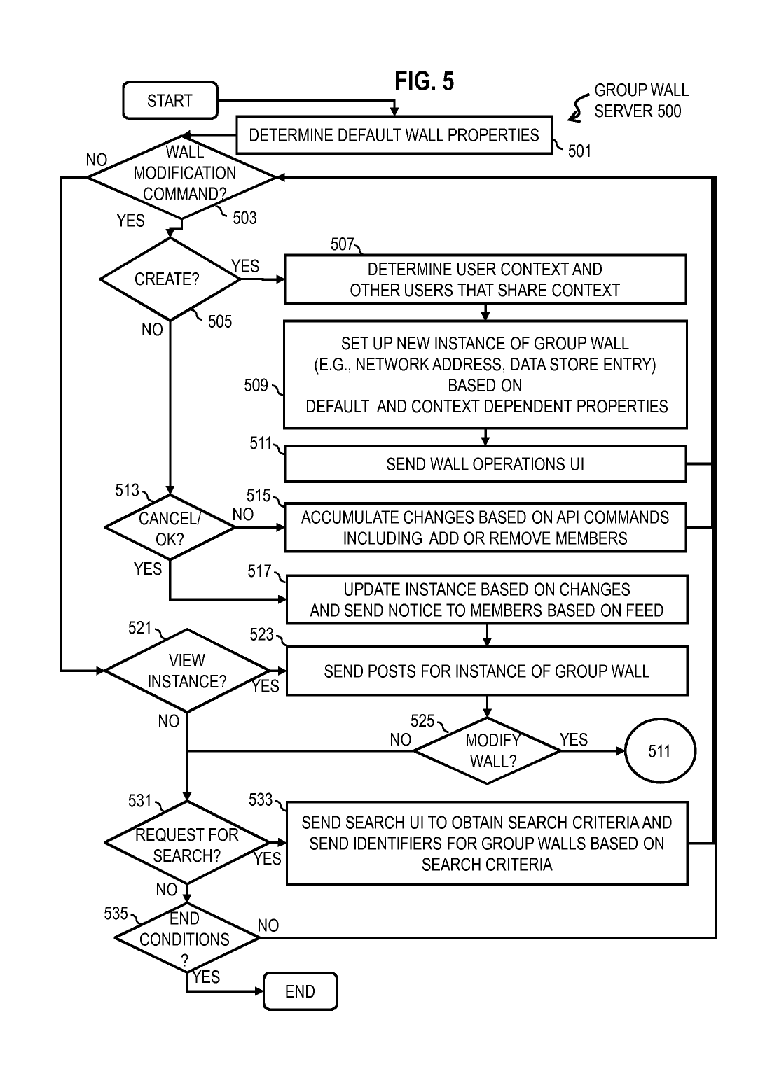

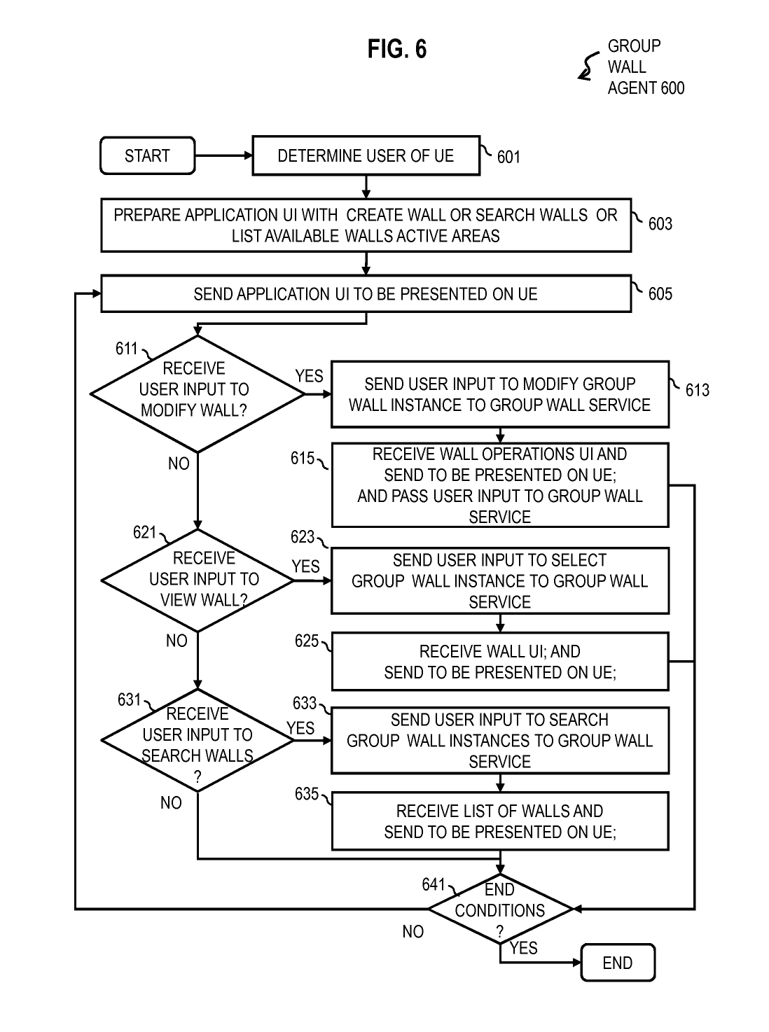

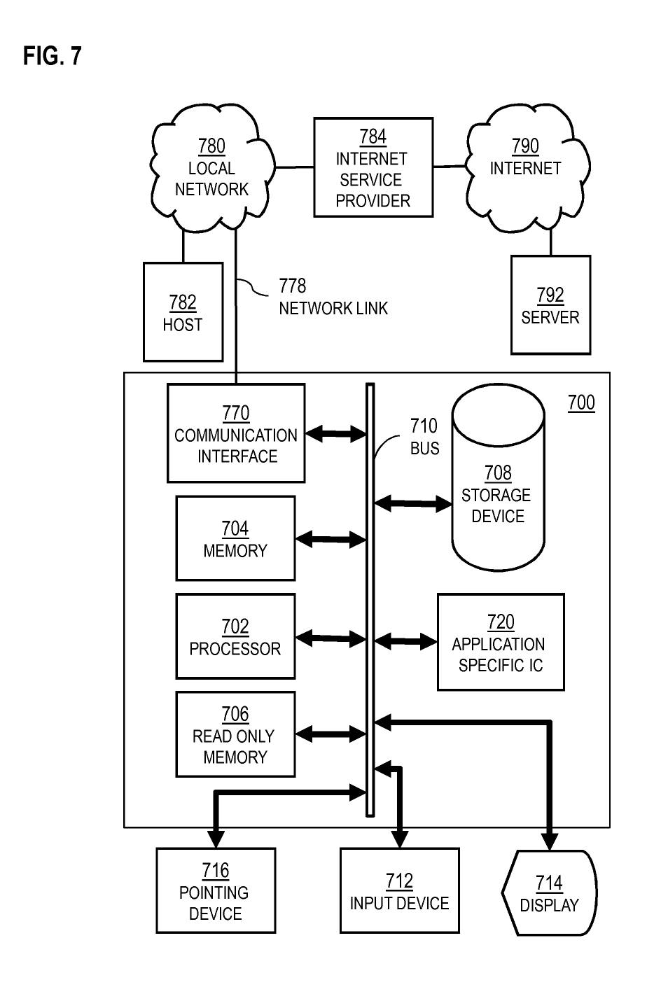

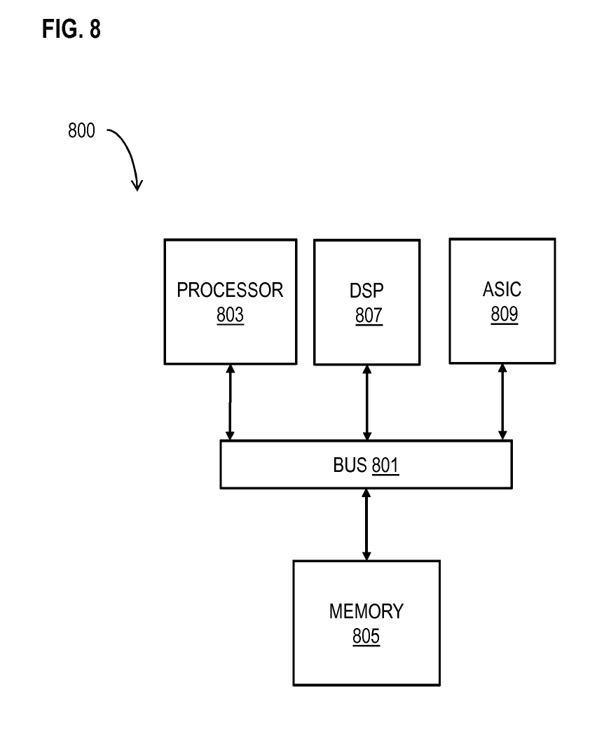

FIG. 3 is a flowchart of a client process 300 on user equipment for sharing of data by dynamic groups, according to one embodiment. In one embodiment, the client 127 performs the process 300 and is implemented on UE 101 in, for instance, a chip set including a processor and a memory as shown in FIG. 8 or mobile terminal as shown in FIG. 9. In various other embodiments, one or more steps or portions thereof are performed by the agent process 129 on a network service or by the group wall service 120, or some combination, and is implemented in, for instance, a computer system as shown in FIG. 7. Although steps are shown in FIG. 3, and in subsequent flowcharts FIG. 5 and FIG. 6, as integral blocks in a particular order for purposes of illustration, in various other embodiments one or more steps or portions thereof are performed in a different order, or overlapping in time, in series or in parallel, or one or more steps or portions thereof are omitted, or additional steps are added, or the methods are changed in some combination of ways.

In step 301, user input for a group wall is received. Any method may be used to receive this input. For example, in some embodiments, during step 301, the user is prompted for input by the group wall client process 127, by a client process of another local application or a network service 110, or by an agent process 129 of a network service 110, or by a web page received from a network service 110 and presented at browser 107, or by a web page received from a group wall service 120 and presented at browser 107, or some combination. For purposes of illustration, it is assumed that some input is received in response to a user interface presented by a separate application, such as a client process of a network service 110, and some input is received in response to a user interface received from the group wall service 120, either through client 127 or through agent 129 or through browser 107.

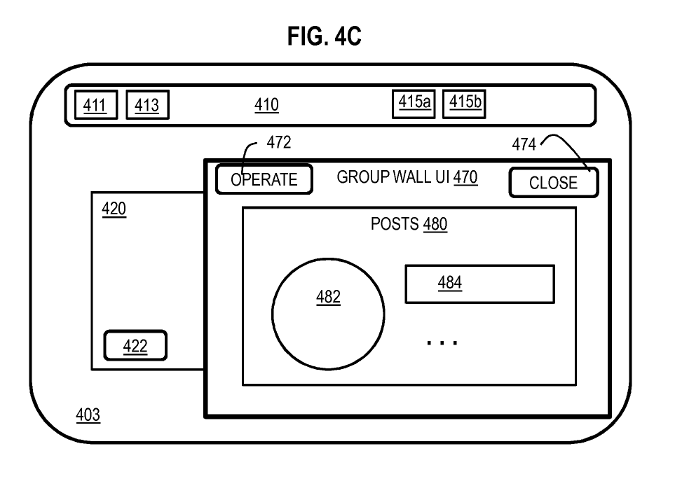

FIGS. 4A-4C are diagrams of user interfaces utilized in the processes of FIG. 3, according to various embodiments. FIG. 4A is a diagram that illustrates an example screen 401 presented at UE 101. The screen 401 includes a device toolbar 410 portion of a display, which includes zero or more active areas. As is well known, an active area is a portion of a display to which a user can point using a pointing device (such as a cursor and cursor movement device, or a touch screen) to cause an action to be initiated by the device that includes the display. Well known forms of active areas are stand alone buttons, radio buttons, pull down menus, scrolling lists, and text boxes, among others. Although areas, active areas, windows ad tool bars are depicted in FIG. 4A through FIG. 4C as integral blocks in a particular arrangement on particular screens for purposes of illustration, in other embodiments, one or more screens, windows or active areas, or portions thereof, are arranged in a different order, are of different types, or one or more are omitted, or additional areas are included or the user interfaces are changed in some combination of ways.

For purposes of illustration, it is assumed that the device toolbar 410 includes active areas 411, 413, 415a and 415b. The active area 411 is activated by a user to display applications installed on the UE 101 which can be launched to begin executing, such as an email application or a video player. The active area 413 is activated by a user to display current context of the UE 101, such as current date and time and location. In some embodiments, the active area 413 is a thumbnail that depicts the current time, or signal strength for a mobile terminal, or both, that expands when activated. The active area 415a is activated by a user to display tools built-in to the UE, such as camera, alarm clock, automatic dialer, contact list, GPS, and web browser. The active area 415b is activated by a user to display contents stored on the UE, such as pictures, videos, music, voice memos, etc.

The screen 401 also includes an application user interface (UI) area 420 in which the data displayed is controlled by a currently executing application, such as a local application like a game or a client process of a network service 110, or a group wall client process 127, or a browser 107.

According to some embodiments, the application UI area 420 includes a SHARE active area 422, and a SEARCH WALLS active area 424, and an AVAILABLE WALLS active area 426. The SHARE active area 422, such as a button, is activated to create a new group wall with one or more digital data items available through the currently executing application. The SEARCH WALLS active area 424, such as a button, is activated to search for content among one or more walls of which the user of the UE 101 is currently a member, as described in more detail below. The AVAILABLE WALLS active area 426, such as a scrolled list with scrollbar 427, lists one or more pre-existing group walls of which the user is a member, and is activated to view a selected group wall. If the user is not a member of a pre-existing group wall, then active area 426 is omitted. In some embodiments, the group walls listed in active area 426 are those established by the currently running application associated with the UI 420. In some embodiments, the group walls listed in area 426 are any group walls of which the user is a member, as provided by the group wall service 120, regardless of the application used to create the wall.

If the user activates the SHARE button 422, a wall operations user interface (UI) is presented. In some embodiments, the SHARE button is deactivated (e.g., grayed out and unresponsive) until the user has selected a digital data item within the application UI area 420, such as a link, an image, or an audio or video clip, to be shared. FIG. 4B is a diagram that illustrates an example screen 402 presented at UE 101. The screen 402 includes the device toolbar 410 portion as well as a wall operations user interface (UI) area 430. In the illustrated embodiment, the wall operations UI area 430 partially obscures the applications UI area 420. The wall operations UI area 430 includes active areas for the user to modify or create a group wall. In the illustrated embodiment, the wall operations UI area 430 includes active areas to indicate a name for a new group wall, one or more other members of the group wall, the digital items to be posted, or the type of notification (feed) to receive when the group wall detects activity, or some combination. In some embodiments, the wall operations UI area 430 is generated by the group wall client 127 on the UE 101. In some embodiments, the wall operations UI area 430 is a web page opened in a browser 107 on the UE 101 by the group wall service 120. In some embodiments, the wall operations UI area 430 is a web page sent from the group wall service 120 to a group wall agent 129 on a network service 110 and is opened in a browser 107 on the UE 101 by the network service 110.

In the illustrated embodiment, the wall operations UI area 430 includes an OK button 432, a CANCEL button 434, an ADD/REMOVE MEMBERS area 440, and active areas 451, 453, 455 and 457. The wall operations UI area 430 can also be evoked for existing group walls, as explained in more detail in a later section. Here, the wall operations UI area 430 is described during creation of a new group wall.

The OK button 432 is activated by a user when the user is finished with operating the other active areas in area 430 and desires that the user input be utilized to create or change the group wall. The CANCEL button 434 is activated by a user when the user is finished with operating the other active areas in area 430 and desires that the user input, since the last activation of the OK button, not be utilized to create or change the group wall.

The NAME active area 451, such as a text box, holds text that indicates a name for the group wall. In some embodiments, a suggested name is indicated in the NAME active area during creation of a new group wall, e.g., based on the first digital data item to be shared or a current context for the UE 101 or some combination. In some embodiments, the NAME active area is blank during creation of a new group wall and the OK button is deactivated until the user enters text into the NAME active area 451.

The OBJECT active area 453, such as a thumbnail image or text box, holds data that indicates a digital data item to be posted by the user of UE 101 to the group wall. In some embodiments, the object is the object selected in the application UI area 420 when the SHARE active area 422 was activated, and is indicated by a thumbnail image or URI or some combination. In some embodiment, the digital data item is member-provided text and active area 453 is a text box displaying the text. In some of these embodiments, the user of the UE 101 is about to enter stand-alone text as a digital data item and the active area 453 is blank until the user types in some text.

The COMMENT active area 455, such as a text box, holds text that indicates a comment to be posted by the user of UE 101 in association with at least one digital data item indicated in OBJECT active area 453.

The FEED active area 457, such as a pull down menu, holds data that indicates the types of feed for the user of UE 101 to be notified of activity on the current group wall. For example, the pull down menu in active area 457 holds choices for one or more of “email” for electronic mail notification, “SMS” for SMS message notification, “wall feed” for automatically opening a wall user interface (as described next with respect to FIG. 4C), if not already opened, upon each new activity for the current group wall, or “aggregate feed” for automatically opening a wall user interface, if not already opened, upon each new activity for any group wall for which the user is a member. In some embodiments, one of the options (e.g., “SMS”) is pre-selected and can be overridden by the user.

The ADD/REMOVE MEMBER area 440 includes one or more active areas for indicating which users are to be added or removed from the members of the group for the group wall. In the illustrated embodiment, the area 440 includes an IN NEAR FIELD active area 442, a SIMILAR CONTEXT active area 444, a BY USER ID active area 446, and a SELF active area 448.

The IN NEAR FIELD active area 442, such as a button, is activated to indicate all users whose equipment are within range of near field communications (NFC). Those users can be determined based on equipment identifiers that are related to corresponding user identifiers in data banks of a network access provider. Upon activating the area 442, a new user interface (not shown) is presented that provides an active area, e.g., a pair of radio buttons, for each user in the near field with an indication of whether each is already a member or not (one button filled if a member, the other button filled if a non-member). The interface also includes an active area for adding all and an active area for removing all (e.g., setting all the radio buttons to member or all the radio buttons to non-member). Thus, in some embodiments, active area 442 includes determining the one or more entities who are currently members of the group based on near field communications.

The SIMILAR CONTEXT active area 444, such as a button, is activated to indicate all users whose equipment are in a similar state, e.g., location, movement, activity, on a contact list, or who are in a similar inferred state, e.g., watching a video at home. Those users can be determined based on context information passed to the group wall service 120. Upon activating the area 444, a new user interface (not shown) is presented that provides an active area, e.g., a pair of radio buttons, for each user with an indication of whether each is already a member or not (one button filled if a member, the other button filled if a non-member). The interface also includes an active area for adding all and an active area for removing all (e.g., setting all the radio buttons to “member” or all the radio buttons to “non-member”). Thus active area 444 provides for determining the one or more entities who are currently members of the group based on contexts of the devices of the one or more entities.

The BY USER ID active area 446, such as a button, is activated to indicate members by user ID. Upon activating the area 446, a new user interface (not shown) is presented that provides an active area, e.g., a text box indicating the user ID for each current member and a radio button to be filled if the indicated user is to be removed. The interface includes at least one blank text box to enter the user ID of a new member.

The SELF active area 448, such as a pair of radio buttons, is activated to indicate the user, called “self”, of the UE 101 on which the UI area 430 is currently presented. One radio button is filled to indicate that self is a member of the group; the other is filled to indicate that self is to be removed from the members of the group. At start, in some embodiments, self is automatically a member.

Upon activating OK, the new group wall is created with the attributes provided, e.g., through one or more API command messages sent to the API 122 of the group wall service 120. The wall operations UI area 430 is closed.

Referring again to FIG. 4A, if the user selects the SEARCH WALLS button 424, a search user interface (not shown) is presented, in which the user can enter search criteria for finding group wall digital data items on any wall for which the user is a member. In various embodiments, the user can search for group wall digital data items by time of creation, location during creation, any other context, or keywords, or some combination.

The available walls area 426 list group walls of which the user of UE 101 is a member, such as all walls, only the group walls most recently created by the user, only one or more group walls with recent activity, or only zero or more walls that satisfy the search criteria. Upon selection of one of these walls by the user of UE 101, a group wall UI area 470 is presented.

FIG. 4C is a diagram that illustrates an example screen 403 presented at UE 101. The screen 403 includes the device toolbar 410 portion as well as a group wall user interface (UI) area 470. In the illustrated embodiment, the group wall UI area 470 partially obscures the applications UI area 420. The group wall UI area 470 includes active areas for the user to view, operate on or close the group wall, or some combination. In some embodiments, the group wall UI area 470 is generated by the group wall client 127 on the UE 101. In some embodiments, the group wall UI area 470 is a web page opened in a browser 107 on the UE 101 by the group wall service 120. In some embodiments, the group wall UI area 470 is a web page sent from the group wall service 120 to a group wall agent 129 on a network service 110 and is opened in a browser 107 on the UE 101 by the network service 110.

In the illustrated embodiment, the group wall UI area 470 includes an OPERATE button 472, a CLOSE button 474, and a POSTS area 480. The CLOSE button is activated to close the group wall UI area 470 and reveal the presentations behind the area 470. The OPERATE button is activated by the user to modify the group wall, e.g., by adding comments or posting new digital data items or changing the membership of the group using the wall operations UI area 430 (described above with reference to FIG. 4B). The posts area 480 presents the digital data items and comments posted to the group walls. For example, an image 482 posted by a member of the group is presented along with a text box 484 showing a comment posted by a member of the group. Other digital data items are indicated by ellipsis. In some embodiments, the digital data items presented in posts area 480 include automatically generated data items that indicate users added or removed from the group. Thus the group wall is a digital data set that includes data that indicates a member added or removed from the group.

Returning to FIG. 3, in step 301 user input is prompted for and received, e.g., using one or more of the user interfaces described above. In step 303, it is determined whether user input indicates a new group wall is to be created. For example, user activation of SHARE active area 422 after selecting an object on the application UI 420 is detected. In various embodiments the determination is made by the client 127 or by the service that sent the application UI to the UE 101, such as a local application, a network service 110 or the group wall service 120. If so, then steps 305 and 307 are performed.

In step 305, the user context is determined for use by the group wall service 120. For example, the client 127 requests the current context of the UE 101a and inferred context of the user from the context engine 103a and receives one or more context tokens in response.

In step 307, it is determined to present the wall operations UI area 430 on the UE 101. In various embodiments, the determination is made by the client 127 or by the service that sent the application UI to the UE 101, such as a local application, a network service 110 or the group wall service 120. If during creation of a new group wall, a group wall identifier is generated, e.g., a sequential number, such as received in a message returned from the group wall service 120. In some embodiments, a suggested name is also provided in step 307 if a name is not already provided by the user. In some embodiments, step 307 includes determining the group wall name, e.g., by detecting a user entry of text into active area 451. The determining process provides the wall operations UI area 430 to the client 127 or the browser 107 which presents the interface on UE 101.

In some embodiments, the CREATE command is generated and sent to the group wall service 120 in an API message during step 307. The CREATE command message indicates the group wall identifier in field 252 and the group wall name and the user who created the group wall and the context of the UE 101 in one or more argument name and value pair fields 256. In some embodiments, the CREATE command API message is placed in a queue in step 307 for sending to the group wall service 120 upon activation of the OK button on the wall operations UI area 430, as described below with reference to step 337.

In step 311, it is determined whether user input indicates one or more members are to be added or removed from the group. For example, user activation of one or more of the active areas 442, 444, 446 or 448 in ADD/REMOVE MEMBER area 440 is detected. In various embodiments the determination is made by the client 127 or by the service that sent the wall operations UI area 430 to the UE 101, such as an agent 129 on a network service 110 or the group wall service 120. If so, then step 313 is performed. Because the ADD/REMOVE MEMBER area 440 is operated to determine who are already members of the group, step 313 includes determining one or more entities who are currently members of the group.

In step 313, users to add or remove from the members are determined for an API message 250 to be sent to the group wall service 120. The ADD (or REMOVE) command message indicates the group wall identifier in field 252 and the user IDs to add to (or remove from) the members in one or more argument name and value pair fields 256. In some embodiments, the ADD or REMOVE command is sent to the group wall service 120 in an API message during step 313. In some embodiments, the ADD or REMOVE command API message is placed in a queue in step 313 for sending to the group wall service 120 upon activation of the OK button on the wall operations UI area 430, as described below with reference to step 337. After the initial creation, subsequent members who are members can add or remove other members. Thus step 313 includes causing, at least in part, actions that result in a change in members of a group based on input from any of the members of the group. Change in members of the first group includes adding a different entity as a member the first group, or removing an entity who is currently a member the first group, or both.

In step 315, it is determined whether user input indicates one or more digital data items are to be posted to the group wall. For example, user activation of one or more of the OBJECT active area 453 or COMMENT active area 455 is detected. In various embodiments, the determination is made by the client 127 or by the service that sent the wall operations UI AREA 430 to the UE 101, such as an agent 129 on a network service 110 or the group wall service 120. If so, then step 317 is performed.

In step 317, objects or comments to post are determined for an API message 250 to be sent to the group wall service 120. The POST (or COMMENT) command message indicates the group wall identifier in field 252 and the object (e.g., image, audio clip, URI) or comment text or user ID of the user of UE 101 in one or more argument name and value pair fields 256. Thus, step 317 includes determining a first digital data set to be shared by devices of all members of a first group. In some embodiments, the POST or COMMENT command is sent to the group wall service 120 in an API message during step 317. As a result, the group wall is a digital data set that includes multiple digital data items posted by one or more members of the group. In some embodiments, the POST or COMMENT command API message is placed in a queue in step 317 for sending to the group wall service 120 upon activation of the OK button on the wall operations UI area 430, as described below with reference to step 337. The posted object and comments are to be stored by the group wall service 120 in field 236 along with the context determined in step 305, which is stored in field 238.

In step 321, it is determined whether user input indicates a feed type for notification of activity on a group wall. For example, user activation of FEED active area 457 is detected. In various embodiments, the determination is made by the client 127 or by the service that sent the wall operations UI AREA 430 to the UE 101, such as an agent 129 on a network service 110 or the group wall service 120. If so, then step 323 is performed.

In step 323, group wall activity notification type is determined for an API message 250 to be sent to the group wall service 120. The FEED command message indicates the group wall identifier in field 252 and the type of activity notification (e.g., email, SMS, wall feed, or aggregate feed) in one or more argument name and value pair fields 256. In some embodiments, the FEED command is sent to the group wall service 120 in an API message during step 323. In some embodiments, the FEED command API message is placed in a queue in step 323 for sending to the group wall service 120 upon activation of the OK button on the wall operations UI area 430, as described below with reference to step 337.

In step 331, it is determined whether user input indicates canceling changes to the group wall (since the last OK active area was activated). For example, user activation of CANCEL button 434 is detected. In various embodiments, the determination is made by the client 127 or by the service that sent the wall operations UI area 430 to the UE 101, such as an agent 129 on a network service 110 or the group wall service 120. If so, then step 333 is performed.

In step 333, API messages 250 to be sent to the group wall service 120 are cancelled. In some embodiments, a CANCEL command is sent to the group wall service 120 in an API message during step 323. In the illustrated embodiment, the queue of API messages is deleted or otherwise emptied without being sent to the group wall service. In step 339, the wall operations UI area 430 is closed.

In step 335, it is determined whether user input indicates accepting changes to the group wall (since the last OK active area was activated). For example, user activation of OK button 432 is detected. In various embodiments, the determination is made by the client 127 or by the service that sent the wall operations UI AREA 430 to the UE 101, such as an agent 129 on a network service 110 or the group wall service 120. If so, then step 337 is performed.

In step 337, API messages 250 accumulated in a queue to be sent to the group wall service 120 are caused to be forwarded to the group wall service 120. In step 339, the wall operations UI area 430 is closed. In some embodiments, one or more of the API command messages are also sent to any members within near field communication (NFC) range, so that such members can share digital data items even in the absence of a connection to the communication network 105 and the group wall service 120.

In some embodiments, step 339 includes adding a newly created group wall to the AVAILABLE WALLS active area 426.

In step 341, it is determined whether group wall is to be presented. For example, it is determined whether the user has selected a group wall from the AVAILABLE WALLS active area 426 to display; or has received a group wall feed for one of the available group walls, or has received an aggregate feed for combined group walls. In various embodiments, the determination is made by the client 127 or by the service that sent the application UI area 420 to the UE 101, such as a local application, a network service 110 or the group wall service 120. If so, then step 343 is performed. In some embodiments, when the communication network 105 is not available, one or more digital data items for the group wall are received from other members within near field communication range (NFC) during step 341.

In step 343, the selected or fed group wall (or aggregate of all the user's group walls) is presented on the UE 101, e.g., in group wall user interface area 470. For example, it is determined to present the group wall UI area 470 on the UE 101. In various embodiments the determination is made by the client 127 or by the service that sent the application UI to the UE 101, such as a local application, a network service 110 or the group wall service 120. The determining process receives the group wall information from the group wall service 120, and provides the group wall UI area 470 to the client 127 or the browser 107 which presents the interface on UE 101. In some embodiments, when connection to communication network 105 is interrupted, step 343 includes displaying one or more digital data items received from other members via near field communications (NFC) using a version of group wall UI area 470 available within a client 127. Thus step 343 includes determining to present the group wall (a digital data set) on a device of a member of the group.

In step 345, it is determined whether user input indicates operating on the presented group wall. For example, user activation of OPERATE button 472 is detected. In various embodiments the determination is made by the client 127 or by the service that sent the group wall UI area 470 to the UE 101, such as an agent 129 on a network service 110 or the group wall service 120. If so, then control passes back to step 305 and following to determine the current context and present the wall operations UI area 430, as described above.

If, in step 345, it is determined that user input indicates not operating on the presented group wall, for example, if user activation of CLOSE button 474 is detected, then step 361 is performed.

In step 361, it is determined whether end conditions are satisfied, e.g., the UE 101 is powering down or an application associated with application UI 420 is closing. If so, then the process ends. If not, then control passes back to step 301 to prompt the user for additional input.

If it is determined in step 303 that a new group wall is not being created, then, in step 351, it is determined whether user input indicates a desire to search group walls for which the user is a member. For example, user activation of SEARCH WALLS button 424 is detected. In various embodiments the determination is made by the client 127 or by the service that sent the application UI to the UE 101, such as a local application, a network service 110 or the group wall service 120. If so, then step 355 is performed, otherwise step 353 is performed.

In step 353 the available group walls for which the user is a member are listed, e.g., in AVAILABLE WALLS active area 426. Control passes to step 341 described above to determine whether an available group wall is selected or activity on one of the available walls has been fed to the UE 101.

In step 355, search criteria are obtained from the user and passed to the group wall service 120 through an API message 250 with a SEARCH command, with the criteria in one or more argument name and value pair fields 256. As described above, the search criteria include keywords, or context tokens, among others, or some combination. Thus, step 355 includes search criteria that include at least one of a location, a person, a digital object type, a keyword, or a context. The results are received from the group wall service 120 in step 355 and listed in step 353, described above.

FIG. 5 is a flowchart of a server process 500 for sharing of data by dynamic groups, according to one embodiment. In one embodiment, the group wall service 120 performs the process 500 and is implemented in, for instance, a chip set including a processor and a memory as shown in FIG. 8 or general purpose computer as shown in FIG. 7. In various other embodiments, one or more steps or portions thereof are performed by the agent process 129 on a network service or by the group wall client 127 on the UE 101, or some combination.

In step 501, default wall properties are determined. For example, the default feed type is set to SMS message.

In step 503, it is determined whether a wall modification API command is received, e.g., CREATE, ADD, REMOVE, POST, COMMENT, or FEED in an API message 250. If not, control passes to step 521, described below. In some embodiments, step 503 includes authenticating the user who sent the API command message, e.g., by verifying that the field identifying the user has a valid authentication token or challenging the user to present credentials, such as a password, and generating an authentication token if the password is correct. In some embodiments, the API command message is forwarded from an agent 129 on a network service 110 that can be trusted to authenticate the user, and no further authentication is performed by the group wall service 120 during process 500.

If it is determined, in step 503, that a wall modification API command is received, then in step 505 it is determined whether the command is the CREATE command. If so, then in step 507 at least some of the context is determined, e.g., based on one or more argument name and value fields 256 in the CREATE API message 250. Other users in the group wall data store 124 that have a similar context are determined as potential members for the new group, e.g., to be presented in response to user selection of SIMILAR CONTEXT active area 444, described above. For example, a post by a user is stored in post field 230 of one or more existing group walls and associates the user ID in field 232 with context tokens in field 238. This information is used, in some embodiments, to discover other users in a similar context to the user creating the new group wall. For example, the context indicated in the create message indicates the UE 101 is located at a particular restaurant at lunch time. Others who recently posted to any group wall in restaurants in the same vicinity at lunch time are identified in the post fields 230 of one or more group wall entry fields 210. In some embodiments, the users with similar context are determined from one or more contacts lists associated with the user creating the group wall, such as social contacts provided by a network service 110 through an agent 129. Thus, step 507 includes determining the one or more entities who are currently members of the first group based, at least in part, on contexts of the devices of the one or more entities. In some embodiments, step 507 is omitted.

In step 509 a new instance of a group wall is prepared. For example, the next sequence number to serve as a group wall ID is determined, a candidate wall entry field 210 is generated with the newly generated sequence number and a default name inserted into the wall ID field 212, and with a first user field 220 with the user ID of the entity sending the create message inserted into the user ID field 222, the current time inserted into field 224, and a default feed type inserted into field 226. In some embodiments, a default name is the same as the sequence number. In some embodiments the default name is based on the user ID (e.g., Alice123) and the first significant term in the context (e.g., restaurant, thus producing a default name “Alice123 restaurant”). A URI link to access a web page that presents that wall entry field 210 is also determined in step 509.

In step 511, the wall operations UI to be presented in area 430 is caused to be sent to the UE 101, either through an agent 129 on a network service 110, or to the client 127 or browser 107 on the UE 101. Any supporting data for the wall operations UI are also sent, such as a default name, a default feed type, and the list of users with similar context. Control passes back to step 503 to determine the next API command received.

If it is determined, in step 505, that the wall modification API command is not a CREATE command, then in step 513, it is determined whether the wall modification API command is a CANCEL or OK command, indicating an end to creation or modification of a group wall. If not, e.g., if the API command is an ADD, REMOVE, POST, COMMENT or FEED command, control passes to step 515.

In step 515, changes to a group wall are accumulated in a candidate wall entry record 210 based on the API commands. For example, one or more POST commands are received. If the user indicated in the message is a member of the group for the wall indicated in the wall ID field 252, then the digital data items from the message are used to add POST fields 230 to the wall entry field 210. Similarly, one or more COMMENT commands are received. If the user indicated in the message is a member of the group indicated in the wall ID field 252, then the digital data items from the message are used to add comment text to the data items field 236 of the wall entry field 210. Thus, step 515 includes determining a first digital data set to be shared by devices of all members of a first group. Step 515 includes determining that the first digital data set (the group wall) comprises a digital data item posted by one member of the first group or multiple digital data items posted by one or more members of the first group.

One or more received ADD commands are also processed during step 515. If the user indicated in the message is a member of the group indicated in the wall ID field 252, then the digital data items from the message are used to add user fields 220 to the wall entry field 210 of the group wall. Similarly, one or more received REMOVE commands are processed during step 515. If the user indicated in the message is a member of the group indicated in the wall ID field 252, then the digital data items from the message are used to remove user fields 220 (or add a remove time to the time field 224) for the wall entry field 210 of the group wall. In some embodiments, when an ADD or REMOVE command is implemented, during step 515, the group wall server adds a post field 230 in which the data items field 236 holds data that indicates the member or members added or removed and by what member the action was initiated. Thus, step 515 includes determining one or more entities who are currently members of the first group. Step 515 also includes causing, at least in part, actions that result in a change in members of the first group based on input from any of the members of the first group. With the ADD command, the change in members of the first group comprises at least adding a different entity as a member the first group. With the REMOVE command, the change in members of the first group comprises at least removing an entity who is currently a member the first group.

One or more received FEED commands are also processed during step 515. If the user indicated in the message is a member of the group indicated in the wall ID field 252, then the digital data items from the message are used to set contents for the feed type field 226 of the wall entry field 210 of the group wall.

If it is determined, in step 513, that the wall modification API command is a CANCEL or OK command, then step 517 is performed. If the API command is CANCEL, all changes since the last OK command are dropped, e.g., the candidate wall entry is not inserted into the group wall data store 200.

If the API command is OK, all changes since the last OK command are accepted, e.g., the candidate wall entry is inserted into the group wall data store 200, and notifications are sent to all remaining members of the group based on the feed type stored in field 226 for that member. For example, an SMS message is sent to each new member that indicates the activity and a URI to access the group wall. An example message is “Alice123 has added you to the group wall Alice123 restaurant at [URI]” where URI indicates an active area in the SMS message that serves as a link that opens the browser 107 on a web page that displays the group wall UI depicted in area 470 in FIG. 4C. Other example notification SMS messages are: “Alice123 has posted a map on the group wall Alice123 restaurant at [URI];” and “Bob456 has removed Charles789 from the group wall Alice123 restaurant at [URI].” If a member of the group wall just updated has asked for a wall feed then (instead of or in addition to sending the SMS message) control passes to step 523, described below. If a member of the group wall just updated has asked for an aggregate feed then step 517 includes (instead of or in addition to sending the SMS message) adding the new post fields to an aggregate web page for the user and control passes to step 523, described below. Otherwise, control passes back to step 503 to process the next API command, as described above. Thus, step 517 includes determining to send a notification message to a device of a newly added member of the first group, wherein the notification indicates an identifier for the first digital data set (e.g., the URI).

In some embodiments, no wall API command messages are received at the group wall service 120 (from the client 127 or agent 129) unless and until the user has selected the OK button 432 on the UE 101. In these embodiments, there is no CANCEL API command or OK API command; and step 513 is omitted. Control passes from step 505 to step 515 to step 517.

If it is determined, in step 50,3 that a wall modification API command is not received, then, in step 521, it is determined whether a request is received to view an instance of the group wall, e.g., a VIEW API command is received. If not, control passes to step 531, described below. If so, then in step 523, it is determined if the user indicated in the message is a member of the group indicated in the wall ID field 252. If so, then one or more digital data items in data items fields 236 for the most recent posts of the wall entry record 210 for the requested group wall are forwarded to the UE 101. Thus steps 521 and 523 include determining to present the first digital data set on the device of the member in response to a request to present the item from the device of the member. The digital data items are sent either directly to a browser 107 on the UE 101 or to client 127 on the UE 101 or indirectly through an agent 129 on a network service 110 to the browser 107 on the UE 101. In some embodiments, the entire group wall UI area 470 is sent from the group wall service 120. In some embodiments, portions of the group wall UI (such as the size and location of area 470 and the operate button 472 and the close button 474) are available in the client 127 and only the digital data from the data items fields 236 are sent to the client 127. Thus, step 523 includes determining to present the first digital data set on a device of a member of the first group.

By receiving one or more additional CREATE API commands (and corresponding OK API commands in some embodiments), additional group walls are created with different memberships. One user can be a member of multiple group walls. Thus, steps 505 through 517 include determining a different second digital data set to be shared by devices of all members of a second group. As a result, the notifications of step 517 include determining to present on a device of an entity who is member of both the first group and the second group data that indicates an identifier for the first digital data set and data that indicates an identifier for the second digital data set, e.g. in AVAILABLE WALLS active area 426.

In step 525, it is determined whether user input indicates the wall is to be modified, e.g., user activation of the operate button 472 is detected. If so, control passes to step 511, described above, to send the wall operations UI area 430, as shown in FIG. 4B. Otherwise control passes to step 531.

In step 531, it is determined whether a request is received to search one or more group walls. For example, it is determined if a SEARCH API command is received. If so, then step 533 is performed. Step 533 includes searching the posts of all group walls for which the requesting user is a member, and finding the group wall IDs of walls that have a highest degree of matching the search criteria. These best matching group walls are presented to the user, e.g., in the AVAILABLE WALLS active area 426 depicted in FIG. 4A, from which one or more can be selected and viewed using the VIEW API command. In some embodiments, only the matching posts are retrieved and aggregated in a web page the URI of which is returned to the requesting UE 101. In some embodiments, the best matching group wall or aggregate of best matching posts is sent to be presented to the user, e.g., in the group wall UI area 470 depicted in FIG. 4C. Control then passes to step 503 to determine the next API command received from a user.

If a SEARCH API command is received without any search criterion, then step 533 includes causing a search user interface (not shown) to be presented on the UE 101 to prompt the user to input search criteria, such as keywords, and contexts to match. In various embodiments, the search UI is available in the client 127, or sent from the agent 127, or sent from the group wall service 120 to the client 127 or browser 107, either directly or through the agent 129. User responses at the UE 101 are used to fill the criteria; and to send a SEARCH API message 250 with search criteria included.

Thus, step 533 includes determining which of the first digital data set and the second digital data set substantively satisfies search criteria received from a device of an entity who is a member of both the first group and the second group. In various embodiments, the search criteria comprise at least one of a location, a person, a digital object type, a keyword, or a context.

In step 535, it is determined if end conditions are satisfied. If so, the process ends. Otherwise, the process continues at step 503, described above.

FIG. 6 is a flowchart of an agent process 600 on a network service for sharing of data by dynamic groups, according to one embodiment. The process 600 is performed by the agent 127 on a network service 110. In step 601, the user of the network service is determined, e.g., through an authorization service based on credentials such as a password. In step 605 a SHARE active area (e.g., button 422) or SEARCH WALLS active area (e.g., button 424) or list of AVAILABLE WALLS active area (e.g., available walls scrolling list 426), or some combination, is included in an application user interface (UI) for the network service. In step 605, the application user interface is presented in area 420.

In step 611, it is determined whether user input that indicates an action to modify a group wall is received, e.g., activation of the SHARE button 422 in the application UI area 420 or activation of the OPERATE button 472 on group wall UI area 470 is detected. If so, then, in step 613, user input to create or modify a group wall is sent to the group wall service via one or more API command messages 250, e.g., a CREATE command or a MODIFY command.

In step 615, the wall operations UI area 430 is requested from the group wall service 120 and sent to the client 127 or browser 107 for presentation on the UE 101. In some embodiments, the agent 129 or client 127 already has the wall operations UI area 430 and step 614 includes requesting only the supporting data from the group wall service 120, such as a wall ID for a new wall or a list of users who have a similar context. User input to the wall operations UI are received from the client 127 or browser 107 and passed on to the group wall service 120 in one or more wall modification API messages 250, such as messages for the CREATE, ADD, REMOVE. POST, COMMENT, and FEED API commands. The group wall service 120 then modifies the group wall data store 124 based on the user input sent in step 615. Control then passes to step 641 to determine if end conditions are satisfied.

In step 621, it is determined whether user input that indicates an action to view a group wall is received, e.g., the user has selected a group wall listed in the AVAILABLE WALLS active area 426. If so, then, in step 623, a command is sent to the group wall service 120 to obtain a view of the selected wall. For example, a VIEW API command message is sent to the API 122 of the group wall service 120, indicating the user. In step 625, the group wall UI area 470, or the digital data items for the posts area 480 are received from the group wall service 120. Step 625 includes sending the group wall UI area 470 or the digital data items for area 480 to the UE 101 to be presented in the group wall UI area 470. Control then passes to step 641.

In step 631, it is determined whether user input that indicates an action to search one or more group walls is received, e.g., user activation of the SEARCH WALLS active area 424 is detected. If so, then, in step 633, the search criteria are determined. In some embodiments, a user interface is caused to be presented on the UE 101, either by sending the UI to the client 127 or browser 107. In some embodiments, the client 127 includes the search criteria UI and the message from the UE 101 indicates the search criteria. When the search criteria are obtained, an SEARCH API command message is sent to the group wall service 120 to search the group wall data store 124. In step 635, a list of group walls (e.g., by wall ID or URI) for the walls that best satisfy the search criteria, or a URI for an aggregate web page made up of the posts that best satisfy the search criteria, is received from the group wall service 120. Step 635 includes sending the list to be presented in the AVAILABLE WALLS active area 426 of the application UI area 420, or opening a window in browser 107 with the web page with the aggregation of posts that satisfy the search criteria. Control then passes to step 641.

In step 641, it is determined if end conditions are satisfied, e.g., closing of the instance of the network service established for the current user. If so, the process ends. Otherwise control returns to step 605 to send the application UI for area 420 to another UE 101.

The processes described herein for sharing of data by dynamic groups may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to share data by dynamic groups as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of sharing of data by dynamic groups.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to sharing of data by dynamic groups. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for sharing of data by dynamic groups. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for sharing of data by dynamic groups, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for sharing of data by dynamic groups with the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to share data by dynamic groups as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of sharing of data by dynamic groups.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to share data by dynamic groups. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of sharing of data by dynamic groups. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of sharing of data by dynamic groups. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to share data within dynamic groups. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a first digital data set to be shared by devices of members of a first group;
determining one or more entities who are currently members of the first group; and
causing, at least in part, actions that result in a change in members of the first group based on input from any of the members of the first group.

2. A method of claim 1, wherein causing, at least in part, actions that result in the change in members of the first group comprises at least adding a different entity as a member the first group.

3. A method of claim 1, wherein causing, at least in part, actions that result in the change in members of the first group comprises at least removing an entity who is currently a member the first group.

4. A method of claim 1, wherein the entity is a person.

5. A method of claim 1, wherein determining the one or more entities who are currently members of the first group further comprises determining the one or more entities who are currently members of the first group based, at least in part, on devices that are in near field communication.

6. A method of claim 1, wherein determining the one or more entities who are currently members of the first group further comprises determining the one or more entities who are currently members of the first group based, at least in part, on contexts of the devices of the one or more entities.

7. A method of claim 1, wherein the first digital data set comprises a digital data item posted by one member of the first group.

8. A method of claim 1, wherein the first digital data set comprises a plurality of digital data items posted by one or more members of the first group.

9. A method of claim 1, wherein the first digital data set comprises data that indicates a member added or removed from the first group.

10. A method of claim 1, further comprising determining to present the first digital data set on a device of a member of the first group.

11. A method of claim 10, wherein determining to present the first digital data set on the device of the member of the first group further comprises determining to present the first digital data set on the device of the member in response to a request to present the item from the device of the member.

12. A method of claim 1, further comprising determining to send a notification message to a device of a newly added member of the first group, wherein the notification indicates an identifier for the first digital data set.

13. A method of claim 1, further comprising determining a different second digital data set to be shared by devices of members of a second group.

14. A method of claim 13, further comprising determining to present on a device of an entity who is member of both the first group and the second group data that indicates an identifier for the first digital data set and data that indicates an identifier for the second digital data set.

15. A method of claim 13, further comprising determining which of the first digital data set and the second digital data set substantively satisfies search criteria received from a device of an entity who is a member of both the first group and the second group.

16. A method of claim 15, wherein the search criteria comprises at least one of a location, a person, a digital object type, a keyword, or a context.

17. An apparatus comprising:
at least one processor; and
at least one memory including computer program code for one or more programs,
the at least one memory and the computer program code configured to, with the at least one processor, cause the apparatus to perform at least the following,
determine a first digital data set to be shared by devices of members of a first group;
determine one or more entities who are currently members of the first group; and
cause, at least in part, actions that result in a change in members of the first group based on input from any of the members of the first group.

18. An apparatus of claim 17, wherein causing, at least in part, actions that result in the change in members of the first group causes the apparatus at least to determine to add a different entity as a member the first group.

19. An apparatus of claim 17, wherein causing, at least in part, actions that result in the change in members of the first group causes the apparatus at least to determine to remove an entity who is currently a member the first group.

20. An apparatus of claim 17, wherein a device of at least one member of the first group is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.
